(19) United States
(12) Patent Application Publication
(10) Pub. No.: US 2012/0193857 A1
(43) Pub. Date: Aug. 2, 2012

(54) ADJUSTABLE FOOD PREPARATION DEVICE

(76) Inventor: MENACHEM RAPHAEL, Mount Dora, FL (US)

(21) Appl. No.: 13/019,487

(22) Filed: Feb. 2, 2011

(51) Int. Cl. B23Q 3/00

(52) U.S. Cl. 269/289 R

(57) ABSTRACT

The present invention relates to an adjustable food preparation device comprising a cutting surface covering an entire upper portion of the adjustable food preparation device, a pair of side walls extending below a set of lateral portions of the cutting surface, a front panel attached below a front portion of the cutting surface, a back panel attached below a back portion of the cutting surface, a set of indentions at a set of lateral ends of the front panel and the back panel, and a hinge attached at a corner between the pair of side walls and the set of indentions wherein the hinge enables the pair of side walls to fold beneath the cutting surface and rest against the set of indentions. The adjustable food preparation device alternates between a standing position and a folded position.

### BACKGROUND OF THE INVENTION

1. Field of the Invention

The present invention relates to a food preparation device with a pair of side walls which adjust to two positions to enable the food preparation device to stand at varying heights.

2. Description of Related Art

Most individuals who cook and prepare meals are familiar with using a cutting board or chopping surface. Many people use their chopping boards on a countertop and then store the boards in a drawer or in a cabinet. Alternatively, some people may own cutting boards that remain on the countertops. Often these cutting boards are made of a thick wood which makes moving the cutting board a chore. Alternatively, the cutting boards may completely cover a large portion of the countertop and essentially take up permanent residence as a part of the counter. These large cutting boards are difficult to store due to their immense size. Along with the large sizes of conventional cutting boards, many times transporting or lifting the cutting board is cumbersome and messy. When a user tries to lift the board the food usually slides off and creates an additional surface to clean.

Some improvements have been made with cutting boards to make them easier to use and easier to move. For example, U.S. Pat. No. 6,745,702 by Steven Lane Goldberg discloses a receptacle cover device with raised work surface wherein a cutting board is disclosed to fit on top of a trash receptacle. The cutting board includes folding legs to enable the cutting board to stand erect upon the trash receptacle and then to become compact for storage. While this device does enable an additional surface for food preparation the location of the additional surface—atop a trash receptacle—may not be desirable for all users, especially when preparing food. Also, when the legs are folded the cutting surface is no longer used for preparation but only for storage.

It would be desirable in the art to provide a food preparation device with a compact and easily storable design that is still useful while in the compact position. It would also be beneficial to provide a food preparation device with multiple heights for use and which enables a user to slide the prepared food from the cutting surface to a plate without having to move the board.

### SUMMARY OF THE INVENTION

In view of the foregoing disadvantages inherent in the prior art, the general purpose of the present disclosure is to provide an adjustable food preparation device comprising a cutting surface covering an entire upper portion of the adjustable food preparation device, a pair of side walls extending below a set of lateral portions of the cutting surface, a front panel attached below a front portion of the cutting surface, a back panel attached below a back portion of the cutting surface, an set of indention at a set of lateral ends of the front panel and the back panel, and a hinge attached at a corner between the pair of side walls and the set of indentions wherein the hinge enables the pair of side walls to fold beneath the cutting surface and rest against the set of indentions. The adjustable food preparation device alternates between a standing position and a folded position.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a perspective view of an adjustable food preparation device in accordance with an exemplary embodiment of the present invention;

FIG. 2 depicts a top view of an adjustable food preparation device in accordance with an exemplary embodiment of the present invention;

FIG. 3 depicts a bottom view of an adjustable food preparation device in accordance with an exemplary embodiment of the present invention;

FIG. 4 depicts a side view of an adjustable food preparation device in a standing position in accordance with an exemplary embodiment of the present invention; and

FIG. 5 depicts a side view of an adjustable food preparation device in a folded position in accordance with an exemplary embodiment of the present invention.

Like reference numerals refer to like parts throughout the description of several views of the drawings.

### DETAILED DESCRIPTION OF THE DRAWINGS

The present invention relates to a food preparation device with a pair of side walls which adjust to two positions to enable the food preparation device to stand at multiple heights. The present invention provides an adjustable food preparation device to make cooking and preparation easier and more convenient. When the adjustable food preparation device is in a standing position or raised position the user may slide the sliced food onto a plate or bowl for cooking. By enabling the user to slide the food into a bowl, the device eliminates transporting the board thus eliminating the messes commonly associated with motion. Alternatively, the adjustable food preparation device collapses into a folded position both for shorter users and for storage. The user may select which height to use the board to provide a personalized chopping and cutting experience.

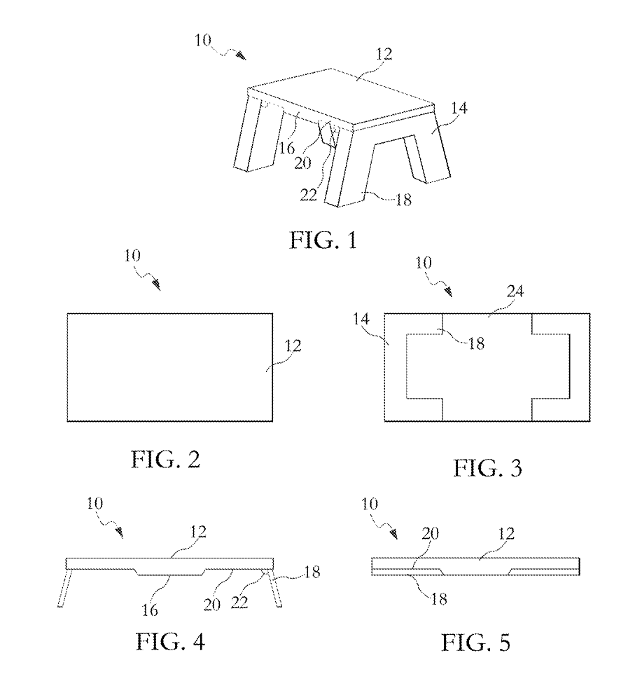

Turning now descriptively to the drawings, referring to FIG. 1, a perspective view of an adjustable food preparation device (10) is shown in accordance with an exemplary embodiment of the present invention. The adjustable food preparation device (10) may comprise a cutting surface (12), a pair of side walls (14), a front panel (16) and a back panel (not shown). The cutting surface (12) may comprise a rectangular, square or even circular shape depending on the preferences of a user, and covers an entire upper portion of the adjustable food preparation device (10). The cutting surface (12) is a generally flat surface to provide a balanced and stable platform upon which the user may cut and prepare their food. The cutting surface (12) may be composed of a hard plastic material, able to withstand prolonged exposure to knives, forks, scraping and slicing. As a decorative element for aesthetic purposes, the cutting surface (12) may come in a variety of colors and patterns.

Accordingly, the pair of sidewalls (14) extends down from the lateral ends of the cutting surface (12). The pair of sidewalls (14) provides the adjustable food preparation device (10) with ability to adjust from a standing position (as shown) to a folded position (as shown in FIG. 3 and FIG. 5). The pair of side walls (14) bend at a hinge (22) attached within the corners where the cutting surface (12) and the pair of side walls (14) meet. The hinge (22) enables the pair of side walls (14) to collapse beneath the cutting surface (12) to comprise the folded position, whereas when the pair of side walls (14) are fully extended perpendicularly from the cutting surface (12) the adjustable food preparation device (10) is in the standing position.

Included at a bottom portion of the pair of sidewalls (14) may be a pair of feet (18). The pair of feet (18) may include a non-slip gripping surface on a base portion that is in contact with a counter or tabletop. The non-slip gripping surface prevents the pair of feet (18) from sliding or shifting while the user is working. Also, a space between the pair of feet (18) may provide a handle or gripping portion for the user to grab when moving or lifting the adjustable food preparation device (10).

Extending an entire length of the cutting surface (12) are the front panel (16) on one side and the back panel on the opposing side. The front panel (16) and the back panel provide greater stability to the adjustable food preparation device (10) so that the cutting surface (12) will not warp or bend when pressure is applied from above by the user while working. Also, at the lateral ends of the front panel (16) and the back panel may be a set of indentions (20). The set of indentations (20) may accept the pair of side walls (14) when they are in the folded position, therefore when the adjustable food preparation device (10) is in the folded position the front panel (16), the back panel and the pair of legs are all flush with the counter or tabletop so as to prevent an uneven cutting surface (12).

Referring now to FIG. 2, a top view of the adjustable food preparation device (10) is shown in accordance with an exemplary embodiment of the present invention. FIG. 2 illustrates the generally rectangular shape of the cutting surface (12), but the cutting surface (12) may also be available in differing shapes and sizes depending on the preferences of the user.

Referring to FIG. 3, a bottom view of the adjustable food preparation device (10) is shown in accordance with an exemplary embodiment of the present invention. A bottom surface (24) of the cutting surface (12) is shown. The sidewalls (14) are illustrated in the folded position wherein the pair of feet (18) point towards each other while resting against the bottom surface (24).

Referring to FIG. 4, a side view of the adjustable food preparation device (10) is shown in the standing position in accordance with an exemplary embodiment of the present invention. The sidewalls (14) are perpendicular to the cutting surface (12) to provide optimal stability during use. Accordingly, the sidewalls (14) raise the cutting surface (12) above the counter enough to enable a bowl or plate to slide between the sidewalls (14). When the bowl or plate is beneath the cutting surface (12) the user may slide the prepared food onto the plate or into the bowl for cooking, serving or eating. Also, when in the standing position, the adjustable food preparation device (10) may be more convenient for use to taller users who may find it difficult to use conventional cutting boards.

Referring to FIG. 5, a side view of the adjustable food preparation device (10) is shown in the folded position in accordance with an exemplary embodiment of the present invention. FIG. 5 illustrates how when the sidewalls (14) are folded beneath the cutting surface (12) the indentation (20) accepts the sidewalls (14) to allow the adjustable food preparation device (10) to lie flat upon the counter.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. An adjustable food preparation device comprising:
a cutting surface covering an entire upper portion of said adjustable food preparation device;
a pair of side walls extending below a set of lateral portions of said cutting surface;
a front panel attached below a front portion of said cutting surface;
a back panel attached below a back portion of said cutting surface;
a set of indentions at a set of lateral ends of said front panel and said back panel; and
a hinge attached at a corner between said pair of side walls and said set of indentions wherein said hinge enables said pair of side walls to fold beneath said cutting surface and rest against said set of indentions.

2. The adjustable food preparation device of claim 1, wherein when said pair of side walls are extended perpendicularly from said cutting surface, said adjustable food preparation device is in a standing position.

3. The adjustable food preparation device of claim 1, wherein when said pair of side walls are folded beneath said cutting surface, said adjustable food preparation device is in a folded position.

4. The adjustable food preparation device of claim 2, wherein said standing position enables a bowl to slide between said pair of side walls, beneath said cutting surface.

5. The adjustable food preparation device of claim 1, wherein said pair of side walls include a pair of feet.

6. The adjustable food preparation device of claim 4, wherein said pair of feet include a piece of gripping material to prevent said pair of feet from sliding.
